(19) United States
(12) Patent Application Publication
(10) Pub. No.: US 2025/0132967 A1
(43) Pub. Date: Apr. 24, 2025

(54) Systems and Methods for Efficient Convergence for Time Servo

(71) Applicants: Kishan Shenoi, Saratoga, CA (US); Hans Brandberg, Skarpnäck (SE); Mary McShea, Portland, OR (US); Christian Blixt, Balsta (SE); Leonid Zhigunov, Märsta (SE)

(72) Inventors: Kishan Shenoi, Saratoga, CA (US); Hans Brandberg, Skarpnäck (SE); Mary McShea, Portland, OR (US); Christian Blixt, Balsta (SE); Leonid Zhigunov, Märsta (SE)

(21) Appl. No.: 19/000,974

(22) Filed: Dec. 24, 2024

Related U.S. Application Data
(60) Provisional application No. 63/714,010, filed on Oct. 30, 2024.

(51) Int. Cl. H04L 27/26

(52) U.S. Cl. CPC H04L 27/2685; H04L 27/2657

(57) ABSTRACT

Systems and methods for packet-based network clock synchronization are provided. An integrated circuit device may include a local clock and a packet-based synchronization servo to apply a control loop to synchronize the local clock with a remote clock. The control loop may include a frequency correction to accelerate convergence.

### CROSS-REFERENCE TO RELATED APPLICATIONS

This application claims priority to U.S. Provisional Application No. 63/714,010 filed Oct. 30, 2024, titled “Systems and Methods for Efficient Convergence of Network-Based Clock,” which is incorporated herein by reference in its entirety for all purposes.

### BACKGROUND

This disclosure relates to systems and methods to achieve convergence during startup of packet-based time synchronization.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Packet-based clock synchronization may be used to synchronize the clocks of two remote integrated circuit devices. Precision Time Protocol (PTP) (IEEE 1588) is one protocol specifying synchronization between a master clock and a subordinate clock (formerly referred to as a slave clock). Timestamps are provided in packets from the master clock and a servo at the subordinate clock may adjust the subordinate clock based on the timestamps. When using a packet protocol such as PTP and the intervening network is noisy, the servo may perform “packet selection,” whereby the timestamp-bearing packets are in observation windows containing multiple packets and a representative delay is extracted from the packets in the window. A longer window duration provides better reduction of network noise but implies a longer convergence interval at start-up. Furthermore, the baseline frequency offset of the local oscillator (LO) of the subordinate clock may be an impediment to the convergence of the clock recovery servo loop. The offset, at best, introduces a long delay at start-up and, at worst, prevents synchronization altogether.

### BRIEF DESCRIPTION OF THE DRAWINGS

Various aspects of this disclosure may be better understood upon reading the following detailed description and upon reference to the drawings in which:

FIG. 1 is a block diagram of a packet-based clock synchronization system;

FIG. 2 is a block diagram of different clocks of the packet-based clock synchronization system;

FIG. 3 is a communication diagram illustrating timing of different packets sent by the packet-based clock synchronization system;

FIG. 4 is a block diagram of a servo of a subordinate of the packet-based clock synchronization system;

FIG. 5 is a diagram illustrating windows of packets received by a subordinate of the packet-based clock synchronization system;

FIG. 6 is a flowchart of a method for improving convergence during a startup of the packet-based clock synchronization system based on adjusting window sizes;

FIG. 7 is a flowchart of a method for determining an initial frequency offset during a startup of the packet-based clock synchronization system to improve convergence;

FIG. 8 is a flowchart of a method for improving convergence during a startup of the packet-based clock synchronization system by performing a packet selection method with a lowest variance; and

FIG. 9 is a block diagram of a data processing system that may incorporate an integrated circuit device implementing the systems and methods of this disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Precision Time Protocol (PTP) (IEEE 1588) or Network Time Protocol (NTP) (RFC 5905) are protocols specifying synchronization between a master clock (e.g., server, source, TimeTransmitter) and a subordinate clock (e.g., client, TimeReceiver, formerly referred to as a slave clock). Timestamps are provided in packets from the master clock and a servo at the subordinate clock may adjust the subordinate clock based on the timestamps. At startup, the servo may perform a variety of processes that may more efficiently achieve convergence on clock synchronization. For example, the servo may perform packet selection using initially smaller windows and iterations and gradually increasing these until convergence is achieved. Additionally or alternatively, the servo may determine an initial frequency offset to more rapidly achieve convergence even when the baseline offset of the local oscillator of the subordinate clock might otherwise prevent synchronization. Additionally or alternatively, the servo may perform packet selection using one of a variety of different methods, selecting the method that has the least variance among all the methods.

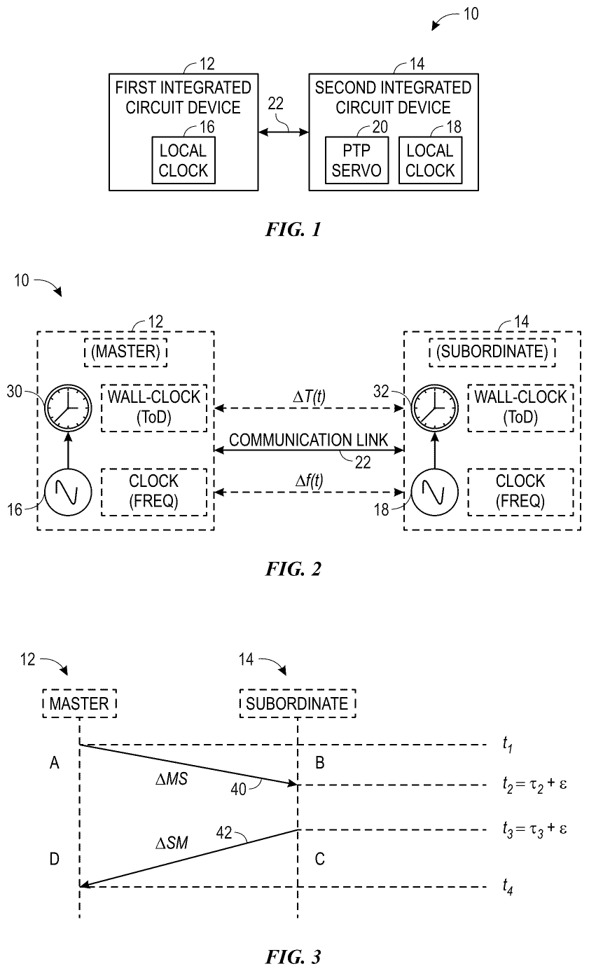

FIG. 1 illustrates a block diagram of a system 10 that may be used to facilitate clock synchronization between a first integrated circuit device 12 and a second integrated circuit device 14. The first integrated circuit device 12 may include a local clock 16. The first integrated circuit device 12 may synchronize its local clock 16 to a local clock 18 of the second integrated circuit device 14 using a packet-based clock synchronization protocol. Any suitable packet-based clock synchronization protocol may be used. One example is Precision Time Protocol (e.g., IEEE 1588-2019, published in November 2019). A PTP servo 20 of the second integrated circuit device 14 may receive timestamped packets from the first integrated circuit device 12 via a communication link 22, which may take the form of any suitable wired or wireless communication medium and/or network communication. The PTP servo 20 may use the timestamped packets to synchronize the local clock 18 of the second integrated circuit device 14 to the local clock 16 of the first integrated circuit device 12. The PTP servo 20 may use any suitable control circuitry to do so. For example, the PTP servo 20 may include a processor that may execute firmware instructions stored on any suitable tangible, non-transitory, machine-readable media (e.g., memory or storage), may include a finite state machine implemented in hardware, or may include any suitable circuit design implemented in soft logic of a programmable logic device, such as a field programmable gate array (FPGA).

FIG. 2 illustrates another view of the system 10 with a focus on the delay of the packets across the communication link 22. The first integrated circuit device 12 may be considered a master. The local clock 16 may provide a clock frequency that updates a wall-clock 30, which is any suitable circuit that may maintain a count corresponding to a time of day (ToD) at the first integrated circuit device 12. Likewise, the second integrated circuit device 14 may be considered a subordinate. The local clock 18 may provide a clock frequency that updates a wall-clock 32, which is any suitable circuit that may maintain a count corresponding to a time of day (ToD) at the second integrated circuit device 14.

The two clocks 16, 18 are frequency aligned (e.g., syntonized) if the clocks 16, 18 have a zero fractional frequency offset (FFO) (e.g., a frequency difference Δf(t) of 0). The two clocks 16, 18 are phase aligned if the ticks are coincident; the two clocks 16, 18 are time aligned if the time value illustrated by the wall-clocks 30, 32 associated with corresponding ticks of the clocks 16, 18 is the same (e.g., a time difference ΔT(t) of 0). It is common to consider the corresponding tick as the principal feature (usually the rising edge) of a 1PPS (one pulse per second) generated by the clock 16 or 18.

Consider the situation where the clock 18 of the subordinate (e.g., client, TimeReceiver, slave) derives its timing from a source (e.g., master, server, TimeTransmitter) over a packet-based communication link/network such as the communication link 22. Packet exchanges between the master (e.g., first integrated circuit device 12) and subordinate (e.g., the second integrated circuit device 14) provide measurements of the transit delay between the two. This is explained with respect to FIG. 3. The protocol, such as PTP or NTP, that is employed determines the method whereby the measurements (e.g., detectable from timestamps in communication packets) are communicated between the two entities.

FIG. 3 illustrates communication that takes place during PTP synchronization between a master (e.g., the first integrated circuit device 12) and a subordinate (e.g., the second integrated circuit device 14). In FIG. 3, the terminology “t” indicates a time value in the master timescale, assumed to be “truth”, and the “t” values represent a time value according to the subordinate ToD clock. The sequence of timestamped events and items of information associated with an exchange of packets between master and subordinate are:

Event A: A packet (“Sync_Message”) 40 is transmitted by the master and the time-of-departure given the label T1 and has the value t₁.

Event B: The Sync_Message packet 40 arrives at the subordinate that measures the time-of-arrival, given the label T2, as t₂; assuming that the Subordinate time error is e, the actual time-of-arrival is t₂=τ₂+ε. The travel time is Δ_{MS}.

Event C: A packet (“Delay_Request”) 42 is transmitted by the subordinate that notes the time-of-departure, given the label T3, is t₃; assuming that the subordinate time error is e, the actual time-of-departure is t₃=τ₃+ε.

Event D: The Delay_Request packet 42 arrives at the master that measures the time-of-arrival, given the label T4, as t₄. The travel time is Δ_{SM}.

The PTP protocol includes another packet (“Delay_Response”) (not shown in FIG. 3) from master to subordinate that contains the value t₄. Such a two-way exchange of packets provides information suitable for allowing the subordinate to align in time with the master. Note that the terminology “Sync direction” will be used for the path from master to subordinate and “Delay direction” will be used for the subordinate-to-master direction.

Denoting by Δ_{MS} and Δ_{SM} the transit delays between the master and subordinate and vice versa, the following equations can be established:

$${t}_{4} = {τ}_{3} + ε + {Δ}_{SM} ( from an S - to - M packet ) \qquad ( 1.1 \text{.1} A )$$

$${t}_{1} = {τ}_{2} + ε - {Δ}_{MS} ( from a M - to - S packet ) \qquad ( 1.1 \text{.1} B )$$

There are just two equations involving three unknowns. However, if delay reciprocity is assumed (e.g., that there may be equal delay in the two directions) then:

$$ε = ( \frac{1}{2} ) ( {t}_{4} - {τ}_{3} - {τ}_{2} + {t}_{1} ) = ( \frac{1}{2} ) ( ( {t}_{4} - {τ}_{3} ) - ( {τ}_{2} - {t}_{1} ) ) \qquad ( 1.1 \text{.2} A )$$

$${Δ}_{MS} = {Δ}_{SM} = ( \frac{1}{2} ) ( ( {t}_{4} - {τ}_{3} ) + ( {τ}_{2} - {t}_{1} ) ) \qquad ( 1.1 \text{.2} B )$$

The time difference between the Subordinate and Master is referred to as “Offset from Master” or OFM.

Thus, from one exchange of time-stamped packets (and one Delay_Response), the subordinate can establish the time error of its ToD clock and can make the correction. It also develops an estimate for the one-way delay as one-half the round-trip delay. However, there are several sources of error that indicate that such exchanges should occur continually. Error in (the estimate of) the local ToD, ε, can be attributed to the following causes:

First, the transit delay in the two directions is not equal. The difference directly affects the ToD (error) estimate. The error, Δe, is given by:

$$Δ ε = ( \frac{1}{2} ) ( {Δ}_{MS} - {Δ}_{SM} ) \qquad ( 1.1 \text{.3} )$$

This error caused by asymmetry is invisible to PTP and may be addressed by other techniques such as pre-deployment or on-demand calibration utilizing an external time reference.

Second, the measured quantities, namely (t₁, τ₂, τ₃, t₄), may not be measured precisely. PTP specifies that timestamping be done in hardware, reducing this uncertainty to essentially the granularity of the time-stamping value.

Third, the transit delays Δ_{MS} and Δ_{SM} are not fixed and can change from packet to packet because of the packet delay variation (PDV) in the network. Note that time-stamp uncertainty can appear to be a component of the PDV.

Fourth, the update rate affects the quality of synchronization. In particular, assuming that the packet delay variation has a flat spectrum (white noise), time-synchronization accuracy improves as the square-root of the update rate. Conversely if the update rate is low, noise mitigation techniques are often less effective.

Fifth, frequency offset and wander of the subordinate clock 18 (frequency), relative to the master clock 16 (frequency), adds a time-varying component of error to the estimate.

Sixth, the use of Synchronous Ethernet (SyncE) provides a way to synchronize the local subordinate clock 18 (frequency) to a “higher-order” reference that is provided by the network with the intention of reducing deleterious impacts of frequency offset and wander of the oscillator in the local subordinate clock 18 (frequency). The terminology “hybrid clock” is used for time-clock arrangements that use a physical-layer reference to control the clock fed to the PTP (time) layer for driving the Time of Day (ToD) counter (e.g., the wall-clock 32).

It has been recognized that the non-linear processing of packet information can provide enhanced suppression of packet delay variation. For example, ITU-T Rec. G.8263 provides a model (FIG. A1 of G.8263) and it is implicit that the update rate of the oscillator control is less than the packet rate.

### Switch Delay Behavioral Model

When a PTP packet traverses the network between the master and the subordinate, it encounters queuing delays in each intervening device that could be a switch or a router across the communication link 22. The delay model discussed here is applicable to all packet-switching devices, but we use the term “switch” for convenience. The description is based on ITU-T Recommendation G.8261, Appendix I. The Appendix identifies the various causes of packet delay variation. Of these, the most consequential is Head-of-Line Blocking. An underlying assumption is that PTP packets are given a very high priority.

The delay profile experienced by a population of high priority packets in conjunction with a strict priority queuing policy may occur during PTP synchronization. For the purposes of simplicity, it may be assumed that packets experience an approximately constant delay through the other switch functions, and may be referred to as “intrinsic propagation delay through switch.” A proportion of packets arrive at the output queue at a time when there are no other packets currently being transmitted. These so-called “lucky packets” are transmitted immediately. The remainder must wait in the queue while the current transmission completes. There may also be an additional delay, due to other high priority packets also in the queue.

The terminology in G.8261 of “frames” was chosen to allow the document to be used in various situations including asynchronous transfer mode (ATM), Frame-Relay, as well as Ethernet. A probability density function (pdf) of the delay through the switch depends on a number of factors. Assuming the PTP does not have competing traffic at its high priority, the pdf can be developed as follows for the single switch case.

Suppose the traffic loading is M %. Then one model of the probability that a PTP packet is “lucky” may be:

$${p}_{L} = \frac{100 - M}{100} \qquad ( 1.2 \text{.1} )$$

An unlucky packet will experience head-of-line blocking. For purposes of explanation, consider that the interfering packets are all the maximum size and require T₁ seconds to clock out at the line rate. Then the PTP packet will experience an additional, queueing, delay between 0 and T₁ seconds and it is reasonable to assume that the distribution is uniform.

The probability density function will be of the form:

$$pdf ( x ) = {p}_{L} \cdot δ ( x - {d}_{L} ) + ( 1 - {p}_{L} ) \cdot U ( x - {d}_{L} ) \qquad ( 1.2 \text{.2} )$$

where d_{L} is the lucky-packet delay and U(x) is the probability density function for a uniform random variable given by:

$$U ( x ) = \{ \begin{matrix}( \frac{1}{{T}_{I}} ) ; 0 \leq x \leq {T}_{I} \\ 0 ; otherwise\end{matrix} \qquad ( 1.2 \text{.3} )$$

If the interfering traffic is of mixed sizes, then the pdf will be of the form:

$$pdf ( x ) = {p}_{L} \cdot δ ( x - {d}_{L} ) + ( 1 - {p}_{L} ) \cdot V ( x - {d}_{L} ) \qquad ( 1.2 \text{.4} )$$

where d_{L} is the lucky-packet delay as before and V(x) is a valid probability density function, other than for a uniform random variable, and is of the form:

$$V ( x ) = \{ \begin{matrix}v ( x ) ; 0 \leq x \leq {T}_{I} \\ 0 ; otherwise\end{matrix} \qquad ( 1.2 \text{.5} )$$

where v(x) is non-negative and

$${\int }_{0}^{{T}_{I}} v ( x ) dx = 1 \qquad ( 1.2 \text{.6} )$$

The lucky-packet delay and the pdf distribution between d_{L} and (d_{L}+T₁) correspond to Eq. (1.2.2) and Eq. (1.2.4). The ITU-T model goes further by indicating the effect of there being more than just the PTP stream at the high(est) priority.

When there is a chain of K switches through which the PTP packets must pass in the communication link 22, the probability of a packet being lucky in all K switches is (P_{L})^{K} and that value diminishes very rapidly with increasing load and increasing K. The general form of the pdf for a network of K switches can be written as (with a slight change of notation):

$$pdf ( x ) = {( {p}_{L} )}^{K} \cdot δ ( x - {d}_{L} ) + ( 1 - {( {p}_{L} )}^{K} ) \cdot V ( x - {d}_{L} ) \qquad ( 1.2 \text{.7} )$$

where d_{L} is the lucky-packet delay over the K switches, Tris the size (in time units) of the largest interfering packet, and other than for a uniform random variable and is a valid probability density function of the form:

$$V ( x ) = \{ \begin{matrix}v ( x ) ; 0 \leq x \leq K \cdot {T}_{I} \\ 0 ; otherwise\end{matrix} \qquad ( 1.2 \text{.8} )$$

where v(x) is non-negative and

$${\int }_{0}^{K \cdot {T}_{I}} v ( x ) dx = 1 \qquad ( 1.2 \text{.9} )$$

Of special interest is that the probability of observing a packet experiencing the lucky-packet delay over the K-switch network is P_{L}=(p_{L})^{K}, which is greater than 0. This is valuable for the notion of “packet selection” which is described further below. Packet selection refers to establishing a representative delay over a window of observation. With a window size of M packets, the expected number of packets experiencing the lucky-packet delay is:

$${N}_{L} = {P}_{L} \cdot M \qquad ( 1.2 \text{.10} )$$

Consequently, if the window size is large, then there is a high likelihood that the minimum selection method, described later, will extract the correct lucky-packet delay. More correctly, the minimum selection method will, with high likelihood, provide the value of lucky-packet delay offset by the current subordinate clock time error.

### PTP Servo Control Loop

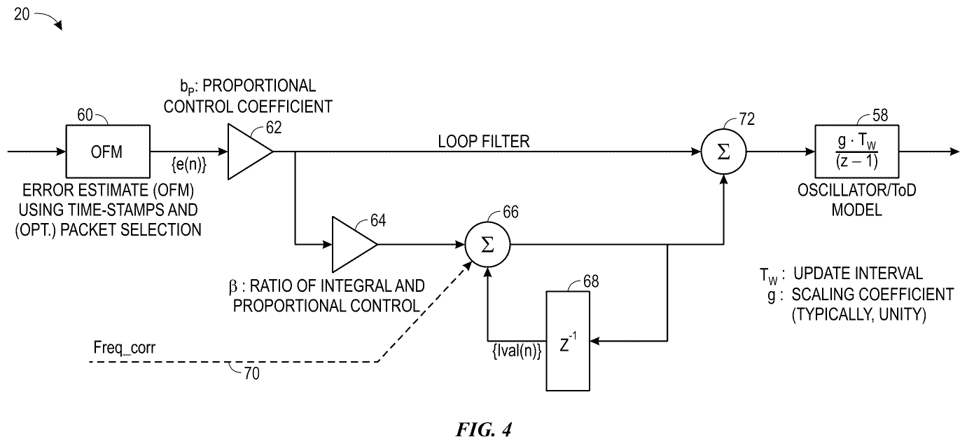

FIG. 4 is a diagram of the structure of a control loop of the PTP servo 20 from a signal processing viewpoint. The PTP servo control loop is implemented as a “P-I loop” where clock control is generated by a combination of “proportional control” and “integral control” components. The oscillator and Time-of-Day (ToD) counter are modeled as an integrator 58.

An OFM (Offset from Master) 60 is generated from the timestamps from the PTP packets of the two directions and may use any of the packet selection mechanisms described later. The purpose of this block is to generate an “error” signal {e(n)}. The action of the PTP servo 20 control loop is to drive this error signal to (ideally) zero. The second order characteristic of the PTP servo 20 control loop has the effect of driving the derivative of the error signal to zero as well. Making the error zero and maintaining it as zero is not practical. Instead, a prescribed threshold value T_{Thresh} may be used that is considered “good enough” (or “synchronized”) if the error magnitude is less than, and stays less than, T_{Thresh} for a sufficient period of time.

The control loop of the PTP servo 20 applies a gain 62 that applies a proportional control coefficient bp and a gain 64 that applies a ratio of integral and proportional control (β) that enters an integral 66. A control loop Integral Control 68 (denoted by {Ival(n)}) can be adjusted independently. This is especially useful to load a frequency offset 72 (freq_corr) of the oscillator of the local clock 18 into the integral 66 control register at start-up, thereby significantly reducing the time the PTP servo 20 control loop takes to stabilize. The result enters an integral 72 to produce an adjustment to the integrator 58.

The PTP servo 20 has several enhancements over other approaches:

First, the PTP servo 20 error is developed not just for time error but a variation that includes an error signal component that is linked to the frequency error. This is depicted by a frequency offset 72 along the dotted line providing “Freq_corr”. The PTP servo 20 can utilize any available estimate of frequency offset 72 to aid in the convergence acceleration. This estimate could be determined by the PTP servo 20 or from external sources. The PTP servo 20 may use a least-squares fit to the information in the timestamps of packets to establish such a frequency estimate and this estimate can be developed for the each of the two directions separately and combined using a weighted scheme whereby the weight for a direction is inversely proportional to the noise power estimate for the same.

Second, as part of the packet selection methods, the PTP servo 20 may determine whether the information available for a window is excessively noisy and should not be used for estimating servo error. Different metrics for characterizing how noisy the information is for the window may include:
Maximum minus minimum of the pseudo-delay
Variance of pseudo-delay
Minimum minus floor of pseudo-delay

Third, this may be done independently for the two directions (Sync and Delay). The servo error development in the PTP servo 20 may be amenable to utilize both directions to establish a time error or to consider a single direction for establishing a frequency error.

Fourth, as noted above, the control loop Integral Control 68 (denoted by {Ival(n)}) can be adjusted independently. This allows the frequency offset 72 (freq_corr) of the oscillator of the local clock 18 to be loaded. This may significantly reduce the time the PTP servo 20 control loop takes to stabilize.

### Packet Selection

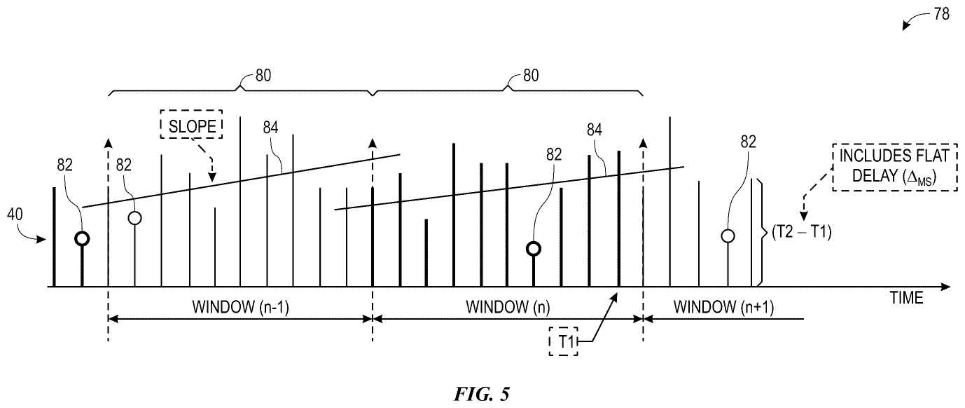

The purpose of packet selection is to mitigate the impact of packet delay variation (PDV). It can be viewed as the process of discarding packets that have untoward delay and retaining those packets with delay characteristics that are more stable. A plot 78 of FIG. 5 illustrates the reception of PTP packets sync_message 40 over windows 80. In each window 80, there is a minimum-delay packet 82. Packet selection is done based on windows 80 of a chosen duration that may be referred to as T_{W} or T_{Wind}. These windows 80 could be overlapping, a situation referred to as a “sliding window”, or non-overlapping but contiguous, where the term “jumping window” applies. The plot 78 of FIG. 5 illustrates jumping windows and, as will be explained later, the oscillator update may be derived every window interval, so window duration coincides with the notion of sampling interval in the digital signal processing (DSP) viewpoint considered for analyzing the behavior.

In FIG. 5, the transfer of the sync_message 40 from master to subordinate is depicted. The time-of-departure from the master is a timestamp T1 contained in each sync_message 40 and the time-of-arrival at the subordinate according to the subordinate's clock is the timestamp T2.

The first estimate of time-of-flight of the packet from master to subordinate is (T2−T1). We refer to this as the “pseudo-delay” because it is includes the “lucky-packet delay” (also sometimes referred to as flat delay), Δ_{MS}, but also includes the effect of the subordinate's clock 18 time error, and also any additional delays introduced by queuing delays in the intervening network elements of the communication link 22. With respect to FIG. 5:
sync_message “pseudo-delay”=(T2−T1)=(τ₂−t₁)=Δ_{MS}+δ+ε (actual flat delay plus delay increase due to queues plus clock error).
Assigned time of message=(T1), which is the master time (hence “true”).
A “slope” 84 may be derived from a least-squares straight-line fit to sequence of (time, pseudo-delay).
The packet selection may be equivalent to establishing a representative pseudo-delay for the window 80. Choices may include: Minimum-delay packet 82 (depicted with circles); average; floor; straight-line fit at mid-point; X % percentile average.

For the n^{th} window we will have Mₙ packets. For a chosen packet rate and window 80 duration, T_{W}, the number of sync_message 40 packets will nominally be the same but in practice it is not always equal to T_{W} times the packet rate, because the packets are not perfectly uniformly spaced, and also because packets could be lost in transit. Denote by {xₙ(k); k=0, 1, . . . , (Mₙ−1)} the calculation of pseudo-delay for the packets in the n^{th} window. Note that in cases where the subordinate clock time error is significant, this calculation of pseudo-delay could possibly result in a negative value.

The mathematical descriptions of different methods for packet selection, essentially establishing a representative delay or pseudo-delay for the window 80, are provided next. Note that a similar construction applies to the reverse direction. Also, it is common to align the start of the window with a Sync_Message packet 40. Here are several of the different methods that may be used for packet selection:
1) Min_x(n): minimum value of the pseudo-delay for packets in the n^{th} window.

$$Min\_x ( n ) = {min}_{k} \{ {x}_{n} ( k ) ; 0 \leq k \leq ( {M}_{n} - 1 ) \} \qquad ( 2.2 \text{.1} )$$

2) Avg_x(n): average value of the pseudo-delay for packets in the n^{th} window.

$$Avg\_x ( n ) = ( \frac{1}{{M}_{n}} ) \cdot {\sum }_{k = 0}^{k = ( {M}_{n} - 1 )} {x}_{n} ( k ) \qquad ( 2.2 \text{.2} )$$

3) Floor: floor(n) is the best estimate of the flat delay Δ_{MS} for the Sync direction (Δ_{SM} is the flat delay for the Delay or reverse direction). The “best guess” for Δ_{MS} based solely on the information in the n^{th} window in Min_x(n). However, because of packet delay variation a suitable adaptive method is needed to home in onto the correct value and the method must also protect against errors introduced by clock error in the past. The PTP servo 20 may implement the floor(n) algorithm as described in the following pseudo-code:

$$IF \{ floor ( n - 1 ) > Min\_x ( n ) \} floor ( n ) = Min\_x ( n ) ;$$

$$ELSE floor ( n ) = floor ( n - 1 ) + coeff * ( Min\_x ( n ) - floor ( n - 1 ) ) ;$$

//the factor coeff is of the order of 0.1 and is experimentally optimized//
4) Based on straight-line fit:
   Consider the straight line yₙ(t) that is the best least-squares fit to the pseudo-delay values in the n^{th} window. This can be expressed as:

$${y}_{n} ( t ) = {β}_{n} + {α}_{n} \cdot ( t - T {1}_{n} ( 0 ) ) ; T {1}_{n} ( 0 ) \leq t \leq T {1}_{n} ( {M}_{n} - 1 ) \qquad ( 2.2 \text{.3} )$$

where αₙ can be recognized as the slope of the line and thus an estimate of the frequency offset of the local clock relative to the Master. The pseudo-delay representative of the window is evaluated as the value of yₙ(t) at the mid-point of the window where t=(T1ₙ(0)+0.5*T_{W}). The goodness of fit, Eₙ, can be computed as the average sum-of-squares of the difference between yₙ and the pseudo-delay values:

$${E}_{n} = ( \frac{1}{{M}_{n}} ) \cdot {\sum }_{k} {( {y}_{n} ( k ) - {x}_{n} ( k ) )}^{2} \qquad ( 2.2 \text{.4} )$$

The value of Eₙ can be used as a proxy for the PDV noise power associated with the n^{th} window when developing weights.
5) X % percentile average: This the average taken over the X % of the least-valued pseudo-delay samples of the window. The intent is to achieve a more stable entity than Min_x(n) and a more precise value than Avg_x(n). For this to be statistically significant and advantage, there must be a large number of packets in the window. A variation of this selection method is to utilize the average of the M least values for {xₙ(k)} in the window. M is a fraction, of the order of (1/10), of the number of packets expected in the window.

One metric for the stability of an estimate is the variance estimated over the recent history. Denote the sequence of the estimate being analyzed by {X(n)}. The following calculations are recursive in nature and can be reasonable representations of stability for the purposes of comparing the different choices of representative pseudo-delay. For the mean or “dc” value:

$$mean ( n ) = α \cdot mean ( n - 1 ) + ( 1 - α ) \cdot X ( n ) \qquad ( 2.2 \text{.5} )$$

The mean-squared (“power”) value may be represented as follows:

$$msq ( n ) = α \cdot msq ( n - 1 ) + ( 1 - α ) \cdot {( X ( n ) )}^{2} \qquad ( 2.2 \text{.6} )$$

And for the variance may be computed:

$$var ( n ) = msq ( n ) - {( mean ( n ) )}^{2} \qquad ( 2.2 \text{.7} )$$

The value of the filter coefficient, a, is necessarily less than 1.0 and preferably greater than 0.9.

For two-way situations, consider the total variance considering both directions. That is, with the notation clear from context,

$${var}_{TOT} ( n ) = {var}_{Delay} ( n ) + {var}_{Sync} ( n ) \qquad ( 2.2 \text{.8} )$$

Developing multiple representative values and establishing a metric that provides guidance as to the noisiness, since the variance is akin to noise power, enables choosing the best method on a dynamic basis.

### Impact of Window Size

The window 80 duration plays a role in the clock recovery scheme. The window 80 duration has a direct impact on the bandwidth of the P-I loop. Specifically, the P-I coefficients are chosen to establish the loop bandwidth as a fraction of the effective sampling rate. The effective sampling rate is the reciprocal of the window duration since we are considering jumping windows. Denoting the chosen fraction as h, the one-sided loop bandwidth, f_{C}, is given by:

$${f}_{C} = η \cdot {f}_{S} = η \cdot ( \frac{1}{{T}_{S}} ) = η \cdot ( \frac{1}{{T}_{W}} ) \qquad ( 2.3 \text{.1} )$$

In Eq. (2.3.1), the sampling rate is f_{S}, the sampling interval T_{S} is equal to the window 80 duration, T_{W}. The inverse relationship between window 80 duration and one-sided loop bandwidth is clear.

The selection process also impacts the noise power, specifically the signal-to-noise ratio (SNR) of the time-error information fed to the P-I loop. The “signal” part of the information content of the pseudo-delay is the lucky-packet delay which is a constant or “dc.” The “noise” part is the variable or “ac” component.

The signal-to-noise ratio improvement is explained for one case of selection, namely considering the action of generating Avg_x(n) where the average value of pseudo-delay may be evaluated over the M values in the window. For convenience, it may be assumed that M is fixed, though because of variations in inter-packet interval, more or fewer than M packets may actually appear in the window.

The pseudo-delay samples {xₙ(k)} can be viewed as

$${x}_{n} ( k ) = θ + {ε}_{n} ( k ) ; k = 0 , 1 , … , ( M - 1 ) \qquad ( 2.3 \text{.2} )$$

where q is the “signal” or constant part that includes the lucky-packet delay and the mean of the distribution of the PDV. The value ε is the “noise” or variable part. Consequently:

$$Avg\_x ( n ) = ( \frac{1}{M} ) \cdot {\sum }_{0}^{( M - 1 )} θ + ( \frac{1}{M} ) \cdot {\sum }_{0}^{( M - 1 )} {ε}_{n} ( k ) \qquad ( 2.3 \text{.3} )$$

From which it may be seen that the signal power remains the same, but the noise power is reduced by a factor of M. Strictly speaking, the reduction by a factor of M applies to “white noise” and that the probability density function has a constant mean, but these are common assumptions for explaining the order of magnitude of SNR improvement because of mathematical tractability.

One reason for a non-constant mean for the pdf is the presence of a frequency offset. The straight-line-fit selection method estimates this frequency offset and its removal, albeit synthetically, provides the desired near-constant mean aspect of the pdf. However, the effect of non-constant load has a deleterious effect because the mean, as well as the variance, is load-dependent and thus obscures the lucky-packet delay. If the load is constant, the mean of the pdf could obscure the lucky-packet delay, but that affects, primarily, the estimate of delay and the constant time error (cTE).

The selection method of taking the minimum value in the window is inherently non-linear and is best explained qualitatively. Since delay is always additive and any transmission or switching activity adds a non-negative delay, the lucky-packet delay is the minimum value of the observed transit delay. However, since the pseudo-delay estimates include the time error of the Subordinate's clock, it is conceivable that there could be an apparent negative delay contribution. The efficacy of the minimum value selection is more pronounced if the network is lightly loaded.

Eq. (1.2.10) provides an expression of the expected number of packets in the window that experience the lucky-packet delay. If the window size is large then there is a high likelihood that the minimum selection method will extract the correct lucky-packet delay. More correctly, the minimum selection method will, with high likelihood, provide the value of lucky-packet delay, albeit offset by the current subordinate clock time error.

### Model of the P-I Loop

With packet selection employed, the sampling interval may match the window size used for packet selection, assuming jumping windows (contiguous but non-overlapping observation windows). The PTP layer noise impact on the output time error can be modeled as a low pass filter (H_{L}). This input to the filter is post packet selection, if any, and contains the packet layer noise (packet delay variation) as well as noise arising from time stamping granularity. The oscillator noise impact on the output time error can be modeled as a high pass filter (H_{H}).

Whereas in Full Timing Support (FTS) scenarios, ITU-T Rec. G.8273.2 provides limitations on the bandwidth of the filters, there is flexibility in the choice of bandwidth in cases that are not FTS, such as the PTP-unaware case or even the Partial Timing Support (PTS) case, or when the subordinate is part of the end application. In this analysis, it may be assumed that the filters can be modelled as simple second order filters with a cut-off frequency of f_{C}. The following equations show the magnitude-squared function since that is what is applicable in estimating the power in terms of the power spectral density.

$${H}_{L} ( f ) = \frac{1}{1 + {( \frac{f}{{f}_{C}} )}^{4}} \qquad ( 2.4 \text{.1} a )$$

$${H}_{H} ( f ) = \frac{1}{1 + {( \frac{{f}_{C}}{f} )}^{4}} \qquad ( 2.4 \text{.1} b )$$

For noise analysis purposes, the “constant time error”, aka cTE, may be ignored, focusing instead on the dynamic time error component, aka dTE. This is because two-way-time-transfer synchronization methods such as PTP and NTP are blind to asymmetry, which is the primary component of constant time error. For the dynamic time error, the total, dTE, as well as a filtered version, dTE_{L}, that is the result of a 0.1 Hz low-pass measurement filter applied to the dTE may be considered, since many standards often provide some performance specifications in terms of limits on dTE_{L}.

### Model of the Oscillator

The oscillator is usually one of the most expensive functional components in any clock implementation. It may be assumed that the applications considered here are reasonably cost sensitive and consequently the oscillator cannot be a super-high-performance device such as an atomic frequency standard. Most likely, the oscillator will be a TCXO (temperature compensated crystal oscillator) or an OCXO (oven-controlled crystal oscillator).

A simplified two-parameter model may be used for analyzing the noise introduced by an oscillator. In particular, for values of observation interval <τ_{K}, also called the “knee”, the behavior is modeled as white frequency modulation (WFM) and for values of observation interval >τ_{K} the behavior is modeled as flicker frequency modulation (FFM). The TDEV can be expressed as:

$$TDEV ( τ ) = \{ \begin{matrix}{A}_{K} \cdot \sqrt{( \frac{τ}{{τ}_{K}} )} ; & τ < {τ}_{K} \\ {A}_{K} \cdot ( \frac{τ}{{τ}_{K}} ) ; & τ \geq {τ}_{K}\end{matrix} \qquad ( 2.5 \text{.1} )$$

It is common that for very large values of observation interval, the behavior is not specified.

A useful, approximate, relation between TDEV, sₕ(t), and power spectrum, sₕ(f) of the noise signal {h(n)}, is given by:

$${S}_{η} ( f ) = ( \frac{0.75}{f} ) \cdot {( {σ}_{η} ( τ = \frac{0.3}{f} ) )}^{2} {( ns )}^{2} / Hz \qquad ( 2.5 \text{.2} )$$

Using the model of Eq. (2.5.1), the following may be obtained from Eq. (2.5.2):

$${S}_{η} ( f ) = \{ \begin{matrix}{A}_{K}^{2} \cdot ( \frac{0.75}{f} ) \cdot ( \frac{0.3}{f \cdot {τ}_{K}} ) ; & f > \frac{0.3}{{τ}_{K}} \\ {A}_{K}^{2} \cdot ( \frac{0.75}{f} ) \cdot {( \frac{0.3}{f \cdot {τ}_{K}} )}^{2} ; & f \leq \frac{0.3}{{τ}_{K}}\end{matrix} \qquad ( 2.5 \text{.3} )$$

This can be rearranged as:

$${S}_{η} ( f ) = \{ \begin{matrix}0.225 \cdot {τ}_{K} \cdot {A}_{K}^{2} \cdot {( \frac{1}{f \cdot {τ}_{K}} )}^{2} ; & f > \frac{0.3}{{τ}_{K}} \\ 0.0675 \cdot {τ}_{K} \cdot {A}_{K}^{2} \cdot {( \frac{1}{f \cdot {τ}_{K}} )}^{3} ; & f \leq \frac{0.3}{{τ}_{K}}\end{matrix} \qquad ( 2.5 \text{.4} )$$

It should be noted that for values of frequency, f, very close to zero, the function may not be defined, in keeping with the earlier observation that TDEV is not specified for very large values of observation interval (τ). Also note that the high pass characteristic of the loop model has a double transmission zero at f=0 and so this non specification of TDEV for large t is not a significant issue.

The noise power the oscillator noise contributes to the output can be computed as

$${σ}_{η}^{2} = 2 \cdot {\int }_{ε}^{0.5 {f}_{S}} {S}_{η} ( f ) \cdot {\vert {H}_{H} ( f ) \vert}^{2} \cdot df \qquad ( 2.5 \text{.5} )$$

As mentioned above, for the dynamic time error, the total, dTE, as well as a filtered version, dTE_{L}, that is the result of a 0.1 Hz low-pass measurement filter applied to the dTE may be used, since standards often provide some performance specifications in terms of limits on dTE_{L}.

A commonly used approach to estimate the maximum value from the standard deviation is to consider the “4-sigma” rule that suggests that:

$$max \vert dTE \vert = 4 \cdot {σ}_{η} \qquad ( 2.5 \text{.6} )$$

Considering that both the oscillator and timestamping noise components are zero-mean processes with probability density functions that can be considered symmetric, the MTIE can be expressed as:

$$max \vert MTIE \vert = 8 \cdot {σ}_{η} \qquad ( 2.5 \text{.7} )$$

Applying the 0.1 Hz measurement filter, HM (f), is accommodated by evaluating

$${σ}_{η L}^{2} = 2 \cdot {\int }_{ε}^{0.5 \cdot {f}_{S}} {S}_{η} ( f ) \cdot {\vert {H}_{H} ( f ) \vert}^{2} \cdot {\vert {H}_{M} ( f ) \vert}^{2} \cdot df \qquad ( 2.5 \text{.8} )$$

resulting in:

$$max \vert {dTE}_{L} \vert = 4 \cdot {σ}_{η L} \qquad ( 2.5 \text{.9} )$$

$$and$$

$$max \vert {MTIE}_{L} \vert = 8 \cdot {σ}_{η L} \qquad ( 2.5 \text{.10} )$$

One observation is that, based on multiple cases with different oscillator characteristics, the following formula provides a good value for the standard-deviation of dTE. For smaller bandwidths (<<0.1 Hz), s_{hL} can be assumed to be essentially equal to sₕ.

$${σ}_{η} \approx 0.33 \cdot ( \frac{{A}_{Knee}}{{τ}_{Knee}} ) \cdot ( \frac{1}{{f}_{C}} ) \qquad ( 2.5 \text{.11} )$$

### Model for PTP-Layer Input Noise

The PTP-layer noise, {x(n)}, at the input to the loop is post-packet selection. The spectrum of {x(n)} depends on a wide range of considerations including, but not limited to, the noise introduced by the network packet delay variation (PDV) on the communication link 22 (also called “network jitter”, among other nomenclature), as well as noise generated in the switches between the PTP master and the PTP subordinate considered as the endpoint clock. The effectiveness of the packet selection algorithm in reducing the variance (power) of the input noise prior to feeding the loop filter is also a consideration. To a first approximation, this will have a white spectrum and have a power of sᵢₙ².

The noise power the PDV contributes to the output can be computed as

$${σ}_{P D V}^{2} = 2 \cdot {\int }_{0}^{0.5 \cdot {f}_{S}} ( \frac{{σ}_{i n}^{2}}{{f}_{S}} ) . \vert {H}_{L} ( f ) {\vert}^{2} \cdot df \qquad ( 2.6 \text{.1} )$$

which can be reduced to

$${σ}_{P D V}^{2} = 2 \cdot ( \frac{{σ}_{i n}^{2}}{{f}_{S}} ) \cdot {\int }_{0}^{0.5 \cdot {f}_{S}} \vert {H}_{L} ( f ) {\vert}^{2} \cdot df = G \cdot {σ}_{in}^{2} \qquad ( 2.6 \text{.2} )$$

where G is the noise-gain of the lowpass characteristic of the loop. In most cases of partial timing support and for PTP-unaware networks, this component will be the dominant contribution.

From the above, it may be seen that to attenuate the PDV noise, the noise-gain, G, should be smaller and that can be achieved with a lower filter bandwidth. It may also be seen that reducing cost by using a lower performance oscillator may entail using a higher filter bandwidth. One way to reduce sᵢₙ, the standard deviation post-selection, is use a larger observation window, T_{S}. However, a larger T_{S} results in a lower f_{S} and thereby a lower filter bandwidth, f_{C}, thereby involving a higher-performance oscillator.

### Parameter Selection

The overarching specification for a clock recovery solution is usually the maximum value of time error, max|TE|. The (total) time error is the combination of constant time error (cTE) and dynamic time error (dTE). It may be valuable to separate these two components because the two-way-time-transfer methods are blind to path asymmetry which is the predominant cause of cTE. The clock recovery specifications applicable to the servo are therefore expressed here in terms of dTE and sometimes dTE_{L}.

The procedure may be explained by way of an example, indicating what trade-offs are involved. A common specification for max|TE| is ˜1.5 us. Providing some allowance for cTE and other sources of time error, it is convenient to ascribe the limit of 1.0 us for the max|dTE|. Following the 4-sigma rule-of-thumb, the standard deviation, S_{dTE}, limit is 250 ns. Since the dTE is the combination of the effect of PDV and the effect of the oscillator, assuming the components are uncorrelated (very reasonable assumption) one may obtain:

$${σ}_{d T E}^{2} = {σ}_{η}^{2} + {σ}_{P D V}^{2} \qquad ( 2.8 \text{.1} )$$

How much to allocate to the oscillator noise is a judgement call. Generally, in PTS and PTP-unaware situations, most of the allocation is for the network (PDV) noise. Here, for specificity, we choose an allocation of ˜5%.

$${σ}_{η}^{2} \leq ( 0.05 ) \cdot {( 250 )}^{2} = 3125 {( ns )}^{2} \qquad ( 2.8 \text{.2} A )$$

$${σ}_{η} < 56 ( ns ) \qquad ( 2.8 \text{.2} B )$$

This limit establishes how small the one-sided loop bandwidth can be, based on the oscillator parameters. For a given oscillator the allowed one-sided minimum bandwidth and the associated noise gain (G) can be computed. It should be emphasized that such an analysis is approximate and useful for identifying the order of magnitude of the parameters as opposed to exact design values.

Having allocated 5% to the oscillator noise, the allocation for the PDV effect is given by:

$${σ}_{P D V}^{2} \leq ( 0.95 ) \cdot {( {σ}_{DTE}^{2} )}_{MAX} = ( 0.95 ) \cdot {( 250 )}^{2} = 59375 {( ns )}^{2} \qquad ( 2.8 \text{.3} )$$

With the choice of oscillator and bandwidth and resulting noise-gain G, an estimate for the maximum allowable post-selection variance may be, using Eq. (2.8.3):

$${σ}_{i n}^{2} \leq \frac{{( {σ}_{P D V}^{2} )}_{M A X}}{G} = \frac{59375}{G} {( ns )}^{2} \qquad ( 2.8 \text{.4} )$$

It should be noted that the estimates of noise power developed based on the spectral method (see, for example, Eq. (2.8.3)) are appropriate for steady state operation.

Note that, in steady state, using as narrow a bandwidth as is feasible for the choice of oscillator, allows for larger input power and thereby allows for increased network packet delay variation. This, in turn, expands the realm of use cases since it reduces the stringency of network specification in terms of loading and extent (e.g., number of devices between Master and Subordinate).

However, there is a trade-off between bandwidth and acquisition time. The acquisition time can be defined as the time interval between start-up and entering the synchronized steady state. This interval will be inversely proportional to the (one-sided) bandwidth. One simple rule of thumb is that the acquisition time is of the order of 10 (1/f_{C}).

### Adjusting Window Size to Improve Startup Convergence

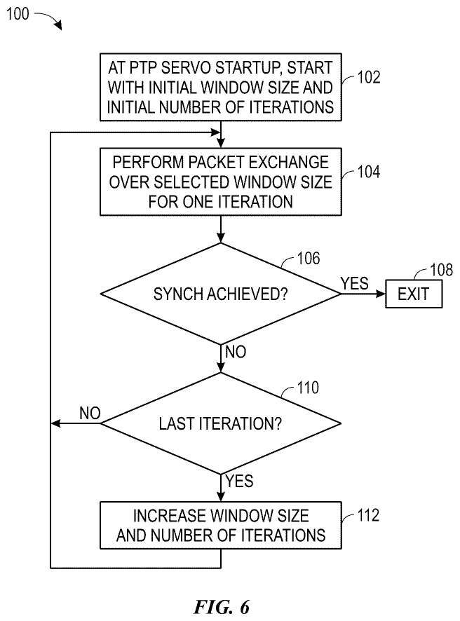

FIG. 6 is a flowchart 100 of a method to improve startup convergence behavior of the PTP servo 20 by adjusting window size. The choice of window size, T_{W}, is generally based on the expected level of PDV and the properties of the oscillator. Denote by (T_{W})ₘₐₓ the value chosen by the designer to meet the specifications of time error variance after we have entered the “synchronized” state. This will be, most likely, the largest value that can be supported by the oscillator performance properties. As shown in Eq. (2.3.1), the servo loop one-sided bandwidth, f_{C}, is inversely proportional to T_{W} and so (T_{W})ₘₐₓ represents the case of steady state where the bandwidth is kept to the smallest possible value to provide the greatest protection against untoward PDV.

Whereas this large value is appropriate for maintaining synchronization, using it at start-up could result in very long convergence times. The convergence could take longer, and possibly very much longer, than N iterations corresponding to a time duration of N·(T_{W})ₘₐₓ. A typical value considered for N is between 10 and 100. If there is a significant oscillator frequency offset or significant PDV, the acquisition duration for a given window could be much longer than N·T_{W}.

The method described here was developed to reduce this convergence time and may be described as follows:

Consider K possible choices for window size, {T_{W}(k); k=1, 2, . . . , K}, where

$${T}_{W} ( 1 ) < {T}_{W} ( 2 ) < … < {T}_{w} ( K ) = {( {T}_{W} )}_{max} \qquad ( 3.1 \text{.1} )$$

At startup (process block 102), the window size may be set to T_{W}(1). Packet exchange may be performed over the selected window size for T_{W}(1) N₁ iterations, one at a time (block 104), and, if synchronization is achieved (decision block 106), a flag may be set to indicate that convergence has been achieved and the startup process may be exited (block 108). As long as synchronization has not been achieved (decision block 106), the selected window size may be maintained for N₁ iterations (decision block 110). If synchronization is not achieved (decision block 106) and the selected number of iterations have been performed (decision block 110), the window size may be increased to T_{W}(2) (decision block 112). The process may repeat. For instance, after N₂ iterations, the window size may be increased to T_{W}(3). This process may continue until the final value for window size of (T_{W})ₘₐₓ and then remains unless there is the need for a reset.

The number of iterations for each stage is a design choice but, generally speaking, the pattern may be:

$${N}_{1} \geq {N}_{2} \geq … \geq {N}_{( K - 1 )} \qquad ( 3.1 \text{.2} )$$

As mentioned above, there may also be a flag available in the PTP servo 20 that indicates whether synchronization has been achieved. This flag can be used to shorten the stages by exiting the stage ahead of the prescribed number of iterations. This method may be particularly effective when there is no significant frequency offset at start-up. Thus, this method would work best if one or more of the following is established:
1. A physical layer reference is provided using Synchronous Ethernet (SyncE) to align the local clock to the network (frequency) reference.
2. The frequency offset of the oscillator is known a priori and is loaded into the Integral Control Word at start-up.
3. The least-squares straight line fit provides a frequency offset estimate that can be used to correct for the oscillator frequency offset.

### Applying Frequency Offset to Improve Startup Convergence

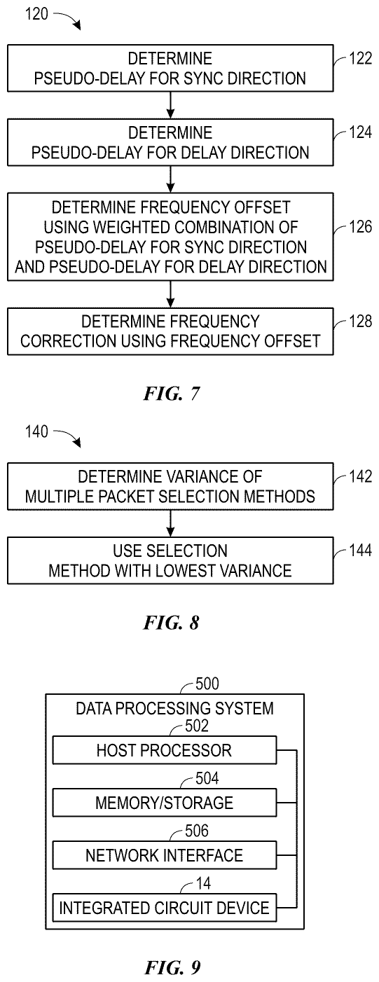

FIG. 7 is a flowchart 120 of another method to improve startup convergence. As noted above, the least-squares straight line fit to the pseudo-delay estimates in the window is of the form (Eq. (2.2.3), repeated here):

$${y}_{n} ( t ) = {β}_{n} + {α}_{n} \cdot ( t - T {1}_{n} ( 0 ) ) ; T {1}_{n} ( 0 ) \leq t \leq T {1}_{n} ( {M}_{n} - 1 ) \qquad ( 2.2 \text{.3} )$$

for the Sync direction. There is an equivalent expression for the Delay direction, but there the time-index value will be based on T4 rather than T1. The goodness-of-fit metric Eₙ (see Eq. (2.2.4)) can be used to establish a suitable weighting for combining the results from the Sync and Delay directions.

In this way, pseudo-delay may be determined for the Sync direction (block 122) and for the Delay direction (block 124). A frequency offset may be determined using these values. For example, denote by wₙ the estimate of frequency offset (in fractional frequency units such as ppb) of the local clock (oscillator). This can be evaluated as the weighted sum of “aₙ” for the two directions:

$${ω}_{n} = ( \frac{{E}_{n} ( S y n c )}{{E}_{n} ( S y n c ) + {E}_{n} ( Delay )} ) \cdot {α}_{n} ( Delay ) - ( \frac{{E}_{n} ( Delay )}{{E}_{n} ( S y n c ) + {E}_{n} ( Delay )} ) \cdot {α}_{n} ( Sync ) \qquad ( 3.2 \text{.1} )$$

This estimate may be used to determine a frequency correction to apply to the servo 20 control loop (Freq_corr) shown in FIG. 4. For example, the frequency correction (Freq_corr) may be applied to the servo 20 control loop as follows:

$$Freq\_corr = \{ \begin{matrix}f gain 1 \cdot {ω}_{n} ( start - up ) \\ f gain 2 \cdot {ω}_{n} ( synchronized )\end{matrix} \qquad ( 3.2 \text{.2} )$$

Here, “fgain1” is a gain term applied if the servo 20 is in a start-up phase and is to adjust the frequency significantly and rapidly. A typical value is around 0.5 (e.g., 0.3, 0.4, 0.5, 0.6, 0.7). In the synchronized state, the gain “fgain2” is used. It is much reduced and will be on the order of 0.01 (e.g., 0.005, 0.008, 0.01, 0.012, 0.015). The frequency correction can be dispensed with when Synchronous Ethernet (SyncE) is utilized.

Packet Selection with Reduced Time Error Variance to Improve Startup Convergence

As described above, there are multiple approaches to establish an appropriate estimate of servo error to feed the P-I loop (see {e(n)} in FIG. 4). There are numerous possible packet selection methods that may be used. Those discussed above include Min_x(n), Avg_x(n), floor(n), straight-line fit, and X % percentile average, but any other suitable packet selection methods may be used. These approaches may be used for establishing a representative pseudo-delay for an observation window. As discussed above, a figure-of-merit for each method can be established in terms of a measure of variance (effectively a power measure).

FIG. 8 is a flowchart 140 that involves determining the variance of multiple packet selection methods (block 142) and using the selection method with the lowest variance (block 144). The method described here is, generally, to utilize the selection method that has the lowest variance. There are some nuances that come into play between two-way and one-way synchronization schemes.

Here, the two-way method specified for phase/time synchronization may be considered. It should be noted that PTP, like all two-way methods, is blind to path delay asymmetry. In this discussion, the asymmetry of path delay is assumed to be zero.

Of the various selection methods, it is the minimum method, “Min_x(n)”, that strives to establish the lucky-packet delay and therefore has the highest potential of driving the time error to zero. The other methods are impacted by the mean-value of the distribution of packet delay variation and effectively strive to drive the time error to a constant value equal to half the difference of the mean-values of the PDV in the two directions. That is, if the PDV for the two directions have different mean values, then there will be an inherent time error akin to asymmetry.

Denote by “X_{Delay}(n)” and “X_{Sync}(n)” the representative pseudo-delays for the two directions based on the selection method with lowest total variance, var_{TOT}(n), for the n^{th} window.

The OFM or “phase error” estimate for this window based solely on this selection method is:

$${ϵ}_{P} ( n ) = ( \frac{1}{2} ) \cdot ( {X}_{D e l a y} ( n ) - {X}_{S y n c} ( n ) ) \qquad ( 3.3 \text{.1} )$$

With this choice of servo error, it is possible to converge with an error that is related to the difference in mean-value of the probability distributions of the PDV in the two directions. The construction of servo error that utilizes the stability of the method that has the least variance but is not impacted by the difference of the mean-values is to use the minimum method to establish the time/phase error and the method with the least variance to develop a servo error component related to frequency error. The frequency error term can be developed as a weighted average of the difference between the representative pseudo-delay estimates of successive windows.

In the following, “X_{Delay}(n)” and “var Delay(n)” are the representative pseudo-delay and associated variance for the selection method that has the least variance in the Delay direction. Likewise, “X_{Sync}(n)” and “var_{sync}(n)” for the Sync direction. The servo error estimate then takes the form:

$$ε ( n ) = ( \frac{1}{2} ) \cdot \{ λ \cdot ( Min {x}_{D e l a y} ( n ) - Min {x}_{S y n c} ( n ) ) + ( 1 - λ ) \cdot Freq\_term \} \qquad ( 3.3 \text{.2} A )$$

where

$$F r e {q}_{term} = ( \frac{{var}_{S y n c} ( n )}{{var}_{S y n c} ( n ) + {var}_{D e l a y} ( n )} ) \cdot ( {X}_{D e l a y} ( n ) - {X}_{D e l a y} ( n - 1 ) ) + ( \frac{{var}_{D e l a y} ( n )}{{var}_{S y n c} ( n ) + {var}_{D e l a y} ( n )} ) \cdot ( {X}_{S y n c} ( n ) - {X}_{S y n c} ( n - 1 ) ) \qquad ( 3.3 \text{.2} B )$$

and the weighting coefficient/is such that 0</<1. A suitable value for the weighting is related to the variance of the minimum selection method and the effective total variance of the methods for the two directions used for “Freq_term”. For example,

$$λ = \frac{{var}_{S y n c} ( n ) + {var}_{D e l a y} ( n )}{{var}_{S y n c} ( n ) + {var}_{D e l a y} ( n ) + {var}_{T O T} ( n ) ( minimum\_selection )} \qquad ( 3.3 \text{.3} )$$

The servo discussed above may be implemented on the integrated circuit device 14, which may be a component included in a data processing system, such as a data processing system 500, shown in FIG. 9. The data processing system 500 may include the integrated circuit device 14 (e.g., a programmable logic device, an application specific integrated circuit (ASIC)), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 20 may include the integrated circuit device 14. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit device 14. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### Example Embodiments

EXAMPLE EMBODIMENT 1. An integrated circuit device comprising:
a local clock; and
a packet-based synchronization servo configured to apply a control loop to synchronize the local clock with a remote clock, wherein the control loop comprises a frequency correction to accelerate convergence.

EXAMPLE EMBODIMENT 2. The integrated circuit device of example embodiment 1, wherein the servo is configured to determine the frequency correction based on timestamped packets received over a plurality of windows.

EXAMPLE EMBODIMENT 3. The integrated circuit device of example embodiment 2, wherein the servo is configured to determine the frequency correction based on a least-squares fit to information provided by the timestamped packets received over the plurality of windows.

EXAMPLE EMBODIMENT 4. The integrated circuit device of example embodiment 2, wherein the servo is configured to determine the frequency correction based on a weighted combination of pseudo-delay of a Sync direction corresponding to packets received from a master device comprising the remote clock and pseudo-delay of a Delay direction corresponding to packets sent to the master device from the integrated circuit device.

EXAMPLE EMBODIMENT 5. The integrated circuit device of example embodiment 4, wherein the servo is configured to determine the pseudo-delay of the Sync direction and the pseudo-delay of the Delay direction separately.

EXAMPLE EMBODIMENT 6. The integrated circuit device of example embodiment 4, wherein the servo is configured to determine the weight for each direction separately.

EXAMPLE EMBODIMENT 7. The integrated circuit device of example embodiment 4, wherein the servo is configured to determine the weight for each direction as inversely proportional to a noise power estimate of that direction.

EXAMPLE EMBODIMENT 8. The integrated circuit device of example embodiment 2, wherein the plurality of windows comprises windows of different sizes, wherein an initial window of the plurality of windows is smaller than a subsequent window of the plurality of windows.

EXAMPLE EMBODIMENT 9. The integrated circuit device of example embodiment 1, wherein the frequency correction is received from a source external to the integrated circuit device.

EXAMPLE EMBODIMENT 10. The integrated circuit device of example embodiment 9, wherein the frequency correction is based on Synchronous Ethernet (SyncE).

EXAMPLE EMBODIMENT 11. The integrated circuit device of example embodiment 1, wherein the servo is configured to determine the frequency correction based on packets selected according to one of a plurality of selection methods with a lowest variance.

EXAMPLE EMBODIMENT 12. A method comprising:
performing packet exchange of time-synchronization packets over a window size for a set of iterations;
using the time-synchronization packets in a control loop of a time-synchronization servo to control a local clock;
when synchronization convergence is not achieved over the window size for the set of iterations, increasing the window size and repeating the method until synchronization convergence is achieved or until a maximum window size or maximum set of iterations is reached.

EXAMPLE EMBODIMENT 13. The method of example embodiment 12, comprising increasing the set of iterations when the window size is increased.

EXAMPLE EMBODIMENT 14. The method of example embodiment 12, wherein the method is performed according to IEEE 1588 Precision Time Protocol.

EXAMPLE EMBODIMENT 15. The method of example embodiment 12, comprising aligning a frequency of the local clock to a frequency of a network clock on which the time-synchronization packets are based.

EXAMPLE EMBODIMENT 16. The method of example embodiment 12, comprising loading a frequency offset into an integral control word of the time-synchronization servo at start-up.

EXAMPLE EMBODIMENT 17. The method of example embodiment 12, wherein using the time-synchronization packets comprises using a least-squares fit over the window size to determine a frequency offset estimate to determine a frequency correction of the local clock in relation to a network clock on which the time-synchronization packets are based.

EXAMPLE EMBODIMENT 18. A method comprising:
receiving a plurality of time-synchronization packets over a network in accordance with a time-synchronization protocol;
determining a variance of a plurality of packet-selection methods using the plurality of time-synchronization packets; and
using a packet-selection method with a lowest variance from among the plurality of packet-selection methods to perform network time-synchronization.

EXAMPLE EMBODIMENT 19. The method of example embodiment 18, wherein the plurality of packet-selection methods comprises a minimum, an average, a floor, a straight-line fit, or percentile coverage, or any combination thereof.

EXAMPLE EMBODIMENT 20. The method of example embodiment 18, wherein performing network time-synchronization comprises determining and applying a frequency correction to a control loop.

What is claimed is:

1. An integrated circuit device comprising:
a local clock; and
a packet-based synchronization servo configured to apply a control loop to synchronize the local clock with a remote clock, wherein the control loop comprises a frequency correction to accelerate convergence.

2. The integrated circuit device of claim 1, wherein the servo is configured to determine the frequency correction based on timestamped packets received over a plurality of windows.

3. The integrated circuit device of claim 2, wherein the servo is configured to determine the frequency correction based on a least-squares fit to information provided by the timestamped packets received over the plurality of windows.

4. The integrated circuit device of claim 2, wherein the servo is configured to determine the frequency correction based on a weighted combination of pseudo-delay of a Sync direction corresponding to packets received from a master device comprising the remote clock and pseudo-delay of a Delay direction corresponding to packets sent to the master device from the integrated circuit device.

5. The integrated circuit device of claim 4, wherein the servo is configured to determine the pseudo-delay of the Sync direction and the pseudo-delay of the Delay direction separately.

6. The integrated circuit device of claim 4, wherein the servo is configured to determine the weight for each direction separately.

7. The integrated circuit device of claim 4, wherein the servo is configured to determine the weight for each direction as inversely proportional to a noise power estimate of that direction.

8. The integrated circuit device of claim 2, wherein the plurality of windows comprises windows of different sizes, wherein an initial window of the plurality of windows is smaller than a subsequent window of the plurality of windows.

9. The integrated circuit device of claim 1, wherein the frequency correction is received from a source external to the integrated circuit device.

10. The integrated circuit device of claim 9, wherein the frequency correction is based on Synchronous Ethernet (SyncE).

11. The integrated circuit device of claim 1, wherein the servo is configured to determine the frequency correction based on packets selected according to one of a plurality of selection methods with a lowest variance.

12. A method comprising:
performing packet exchange of time-synchronization packets over a window size for a set of iterations;
using the time-synchronization packets in a control loop of a time-synchronization servo to control a local clock;
when synchronization convergence is not achieved over the window size for the set of iterations, increasing the window size and repeating the method until synchronization convergence is achieved or until a maximum window size or maximum set of iterations is reached.

13. The method of claim 12, comprising increasing the set of iterations when the window size is increased.

14. The method of claim 12, wherein the method is performed according to IEEE 1588 Precision Time Protocol.

15. The method of claim 12, comprising aligning a frequency of the local clock to a frequency of a network clock on which the time-synchronization packets are based.

16. The method of claim 12, comprising loading a frequency offset into an integral control word of the time-synchronization servo at start-up.

17. The method of claim 12, wherein using the time-synchronization packets comprises using a least-squares fit over the window size to determine a frequency offset estimate to determine a frequency correction of the local clock in relation to a network clock on which the time-synchronization packets are based.

18. A method comprising:
receiving a plurality of time-synchronization packets over a network in accordance with a time-synchronization protocol;
determining a variance of a plurality of packet-selection methods using the plurality of time-synchronization packets; and
using a packet-selection method with a lowest variance from among the plurality of packet-selection methods to perform network time-synchronization.

19. The method of claim 18, wherein the plurality of packet-selection methods comprises a minimum, an average, a floor, a straight-line fit, or percentile coverage, or any combination thereof.

20. The method of claim 18, wherein performing network time-synchronization comprises determining and applying a frequency correction to a control loop.
